(19) United States
(12) Patent Application Publication
(10) Pub. No.: US 2003/0167239 A1
(43) Pub. Date: Sep. 4, 2003

(54) Network address in a postage field

(76) Inventor: Susan M. F. Davis, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/087,331

(22) Filed: Mar. 1, 2002

(51) Int. Cl. G06F 17/60

(52) U.S. Cl. 705/404; 705/401

(57) ABSTRACT

An information delivery system is disclosed that is comprised of a postage system and a server system. The postage system applies postage and a network address to the objects in a postage field on the objects. The postage field is an area reserved on the objects for the postage. The objects are delivered to users. One of the users enters the network address into a user system to generate a first message. The server system receives the first message over the Internet from the user. The first message is addressed to the network address. The server system processes the first message to retrieve information. The server system transfers the information in a second message over the Internet to the user. The network address may also be included in a postmark used to cancel the postage.

### BACKGROUND OF THE INVENTION

1. Field of the Invention

The invention is related to the field of delivery systems, and in particular, to applying a network address in a postage field along with postage. The invention also relates to including a network address in a postmark used to cancel postage.

2. Statement of the Problem

The United States Postal Service (USPS) is one of many delivery services that a person can choose from to deliver a package. The USPS charges a fee for delivering packages. The fee is paid in the form of postage and the USPS typically requires that a package include postage before delivering the package. The amount of the postage depends on the weight and size of the package. The amount of the postage also depends on the type of service used to deliver the package, such as next day delivery, first class mail, certified, etc. The postage indicates the amount of money that has been paid for the package to be delivered.

One example of postage is postage stamps. Another example of postage is metered postage that is printed by postage printing devices. A postage printing device interfaces with a postage meter belonging to the USPS. A customer applies for a postage meter with the USPS. If approved, the USPS leases the postage meter to the customer. The customer pre-pays for postage on the postage meter. For example, the customer would pre-pay for $250 worth of postage that is programmed onto the postage meter. The customer then buys or leases a postage printing device, which is not supplied by the USPS. Some examples of companies that manufacture postage printing devices include Pitney-Bowes and NeoPost. The customer interfaces the postage meter with the postage printing device to print the metered postage. Each time the postage printing device prints the metered postage, the postage meter decrements against the pre-paid amount.

To send a package, the sender affixes postage onto the package and gives the package to the USPS. The USPS sorts the package so that it is delivered to the proper location. The USPS also cancels or marks the postage indicating that is has been used. Canceling the postage usually involves stamping the postage with an ink mark. One example of canceling postage is a stamping the postage with a postmark. Postmarks are generally customized to show the date and the name, state, and ZIP code of the post office handling the package. The postmark indicates to the USPS that the postage cannot be used again. The USPS then delivers the package to the destination address.

Other delivery services operate in a similar manner as described above. Examples of other delivery services include the United Parcel Service (UPS) and Federal Express (FedEx).

The USPS designates a postage field on a package on the upper right hand portion of a package. The postage field is an area reserved on the package for the postage. Postage is affixed on the package in the reserved area. The postage is placed at a consistent location on each of the packages being delivered by the USPS. Having the postage at a consistent location allows for automated canceling of postage and makes manual canceling of postage easier.

The postage field designated by the USPS currently includes postage information that is mostly useful to the USPS and can be a waste of space on the package. For instance, the postage information on metered postage includes “U.S. Postage”, the amount of the postage, a serial number of the postage meter, the date, etc. Because the postage is prominently displayed on a package at a consistent location, the postage is easily seen by the recipient and other people. Therefore, the postage field could be a good location for advertising information. Unfortunately, the postage field is reserved for postage information and USPS does not allow or provide for advertising in the postage field.

Some postage printing devices can be configured to print limited, short advertisements and possibly company logos on an envelope at the same time the postage printing device is affixing the postage to the envelope. However, the postage printing devices are not configured to print the advertisements and company logos in the postage field. Therefore, the advertisements and company logos are not necessarily placed at a consistent location on the envelopes. For instance, a west coast branch of a company may print an advertisement on the bottom left of an envelope while an east coast branch of the same company may print the advertisement on the back of the envelope, depending on the different types of postage printing devices used.

Some postage printing devices are configured to print a special message next to or in line with the postage field. For instance, some postage printing devices can print “Happy Holidays” in or near the postage field. Other postage printing devices can print “RECYCLE” along with the recycle symbol in this area. However, the postage field has yet to be used for commercial advertising.

### SUMMARY OF THE SOLUTION

The invention helps solve the above problems with methods, systems, and software products that include a network address in a postage field of an object. Including the network address in the postage field advantageously provides advertising for the network address. Including the network address in the postage field places the network address at a consistent location on each object. The consistent location of the network address advantageously allows users to automatically scan the network address and access a server system addressed by the network address. This promotes information transfer between a user and the server system addressable by the network address.

One embodiment of the invention includes an information delivery system comprised of a postage system and a server system. The postage system applies postage and a network address to objects in a postage field on the objects. The postage field comprises an area reserved on the objects for the postage. The objects are delivered to users. One of the users enters the network address into a user system and the users system generates a first message. The server system receives the first message over the Internet from the user. The first message is addressed to the network address. The server system processes the first message to retrieve information. The server system transfers the information in a second message over the Internet to the user.

Another embodiment of the invention comprises a software product. The software product includes application software configured to direct a processing system to generate an instruction to apply postage and a network address to objects in a postage field on the objects. The postage field comprises an area reserved on the objects for the postage. The processing system transfers the instruction to a postage system for applying the postage and the network address to the objects. The objects are delivered to users. One of the users enters the network address into a user system and the users system generates a first message. The processing system receives the first message over the Internet from the user. The first message is addressed to the network address. The processing system processes the first message to retrieve information. The processing system transfers the information in a second message over the Internet to the user.

Another embodiment is a method of operating an information delivery system. The method includes applying postage and a network address to objects in a postage field on the objects. The postage field comprises an area reserved on the objects for the postage. The objects are delivered to users. One of the users enters the network address into a user system and the users system generates a first message. The method further includes receiving the first message over the Internet from the user. The first message is addressed to the network address. The method further includes processing the first message to retrieve information. The method further includes transferring the information in a second message over the Internet to the user.

### DESCRIPTION OF THE DRAWINGS

The same reference number represents the same element on all drawings.

FIG. 1 illustrates an information delivery system in an example of the invention.

FIG. 2 illustrates an object that includes a network address in a postage field in an example of the invention.

FIG. 3 illustrates a processing system in an example of the invention.

FIG. 4 illustrates a method of operating an information delivery system in an example of the invention.

FIG. 5 illustrates an object that includes a network address in a postmark in an example of the invention.

### DETAILED DESCRIPTION OF THE INVENTION

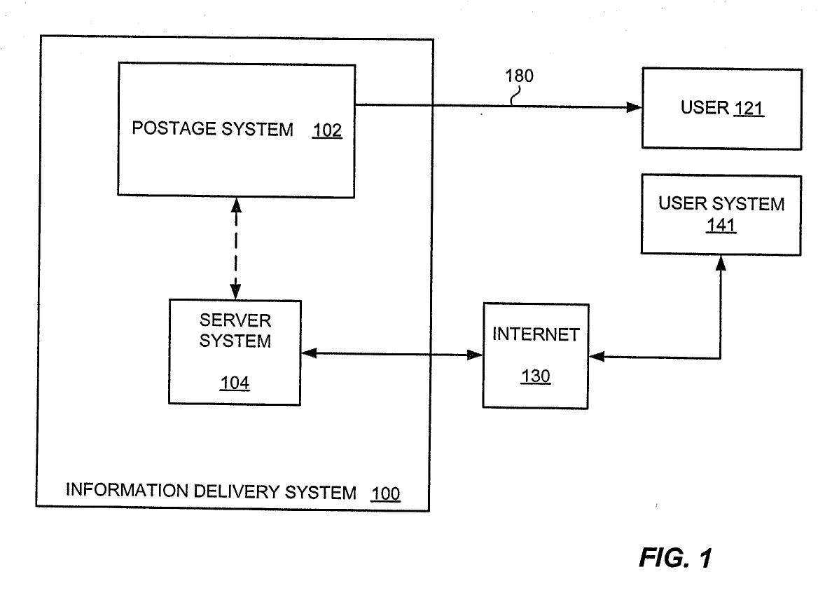

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

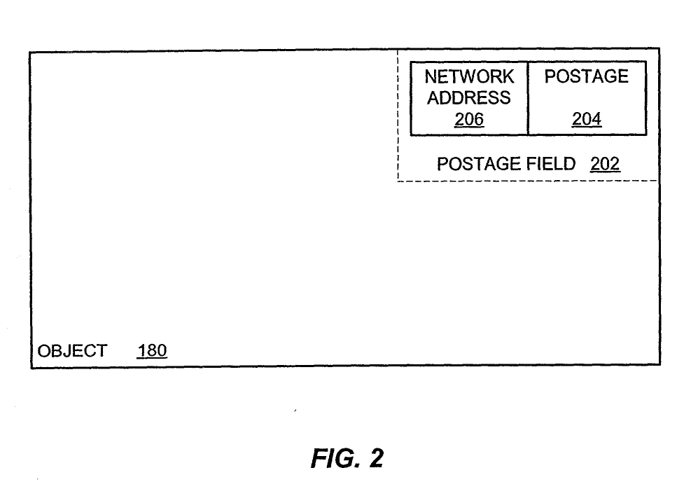

Information Delivery System—FIGS. 1-2

FIG. 1 illustrates an information delivery system 100 in an example of the invention. The information delivery system 100 is comprised of a postage system 102 and a server system 104. In the context of the invention, an object is a post card, an envelope, a container, a box, or any item that can be physically delivered. Postage is any indication of payment for a delivery service. Examples of postage are a postage stamp and metered postage. A postage field is any area on a tangible object that is reserved for postage. The postage field could be designated by a delivery service. A delivery service is any entity that facilitates the delivery of an object for a fee, such as the USPS. A network address is any indicator that can be used to access a server system over the Internet.

FIG. 2 illustrates an object 180 in an example of the invention. Object 180 includes a postage field 202. Postage field 202 is depicted in FIG. 2 in the upper right hand corner of object 180 for illustrative purposes. However, the postage field 202 could be any area on object 180. The postage field 202 is comprised of postage 204 and a network address 206. As can be seen by FIG. 2, network address 206 is included in the postage field 202, and is not limited to areas outside of the postage field 202 as in the prior art. The position of postage 204 and network address 206 relative to one another in the postage field 202 is just an example. Network address 206 could be above postage 204, below postage 204, on the right side of postage 204, on in any other position relative to postage 204, as long as network address 206 remains in the postage field 202.

In operation, postage system 102 applies postage 204 and network address 206 to object 180 in postage field 202 on object 180. Those skilled in the art will appreciate that postage system 102 applies postage 204 and network address 206 to multiple objects. The operation of other devices and systems may be discussed along with the operation of postage system 102 and server system 104, but is not intended to limit the scope of the invention. Object 180 is delivered to user 121. Those skilled in the art will appreciate that user 121 could receive object 180 from the USPS, UPS, FedEx, or any other delivery service. User 121 enters network address 206 into user system 141 and user system 141 generates a first message. User 121 could enter network address 206 into user system 141 by automatically scanning network address 206 from object 180 with user system 141. In such a case, user system 141 comprises a computer with a scanner or scanning input device. User 121 could also enter network address 206 into user system 141 manually.

Server system 104 receives the first message over the Internet 130 from user system 141. The first message is addressed to network address 206. Server system 104 processes the first message to retrieve information. Server system 104 transfers the information in a second message over the Internet 130 to user system 141. Based on this disclosure, those skilled in the art will appreciate how to modify existing information delivery systems to make information delivery system 100.

In one embodiment of the invention, postage system 102 applies network address 206 in the postage field 202 at a consistent location on the object 180 to enable user 121 to automatically scan the postage field 202 for network address 206 with user system 141.

In another embodiment of the invention, postage system 102 comprises a postage printing device. Postage system 102 receives weight information for object 180 and applies postage 204 in an appropriate amount based on the weight information and the type of service specified.

In another embodiment of the invention, network address 206 comprises an Internet address. One example of an Internet address is “128.10.1.0”. In another embodiment, network address 206 comprises a domain name. One example of a domain name is “www.hp.com”.

In another embodiment of the invention, server system 104 is configured to change network address 206 applied by postage system 102. To change network address 206, server system 104 generates a network address message and transmits the network address message to postage system 102. Postage system 102 then applies the network address 206 identified in the network address message. For instance, Company x may be running different promotions each month. In the first month, Company x wants network address A applied to object 180. In the second month, Company x wants network address B applied to object 180. Server system 104 can change network address 206 applied by postage system 102 by changing the network address message.

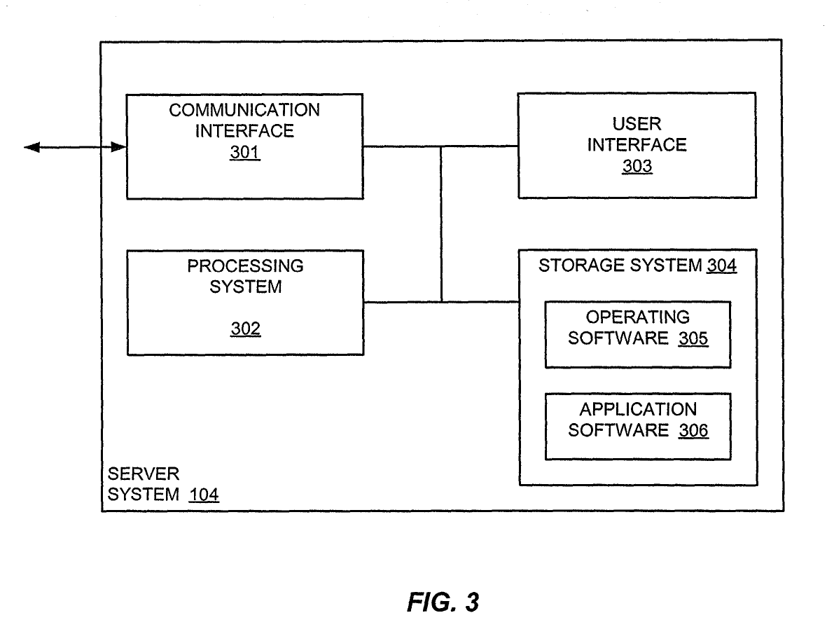

Server System and Application Software—FIG. 3

FIG. 3 illustrates server system 104 in an example of the invention. Server system 104 includes communication interface 301, processing system 302, user interface 303, and storage system 304. Storage system 304 stores operating software 305 and application software 306. Processing system 302 is linked to communication interface 301, user interface 303, and storage system 304. Server system 104 could be comprised of a programmed general-purpose computer, although those skilled in the art will appreciate that programmable or special purpose circuitry and equipment may be used. Server system 104 may use a client server architecture where operations are distributed among a server system and client devices that together comprise elements 301-306.

Communication interface 301 is configured to interface processing system 302 with the Internet 130 and postage system 102. Communication interface 301 could comprise a network interface card, modem, port, or some other communication device.

Communication interface 301 may be distributed among multiple communication devices. Processing system 302 could comprise a computer microprocessor, logic circuit, or some other processing device. Processing system 302 may be distributed among multiple processing devices. User interface 303 could comprise a keyboard, mouse, voice recognition interface, microphone and speakers, graphical display, touch screen, or other types of user devices. Storage system 304 could comprise a disk, tape, integrated circuit, server, or some other memory device. Storage system 304 may be distributed among multiple memory devices.

Processing system 302 retrieves and executes operating software 305 and application software 306 from storage system 304. Operating software 305 may comprise an operating system, utilities, drivers, networking software, and other software typically loaded onto a general-purpose computer. Application software 306 could comprise an application program, firmware, or some other form of machine-readable processing instructions. When executed by processing system 302, application software 306 directs processing system 302 to operate in accord with the invention.

Application software 306 directs processing system 302 to perform the following operations while in communication with postage system 102 through communication interface 301. The operation of other devices and systems may be discussed along with the operation of processing system 302, but is not intended to limit the scope of the invention. Processing system 302 generates an instruction to apply postage 204 and network address 206 to object 180 in postage field 202. Processing system 302 transfers the instruction to postage system 102. Postage system 102 applies postage 204 and network address 206 to object 180 in postage field 202 responsive to the instruction from processing system 302. Those skilled in the art will appreciate that processing system 302 generates multiple instructions to apply postage 204 and network address 206 to multiple objects. Object 180 is delivered to user 121. Those skilled in the art will appreciate that user 121 could receive object 180 from the USPS, UPS, FedEx, or any other delivery service. User 121 enters network address 206 into user system 141 to generate the first message.

Processing system 302 then receives the first message over the Internet 130 from user system 141. The first message is addressed to the network address 206. Processing system 302 processes the first message to retrieve information. Processing system 302 transfers the information in a second message over the Internet 130 to user system 141. Based on this disclosure, those skilled in the art will appreciate how to modify existing application software to make application software 305.

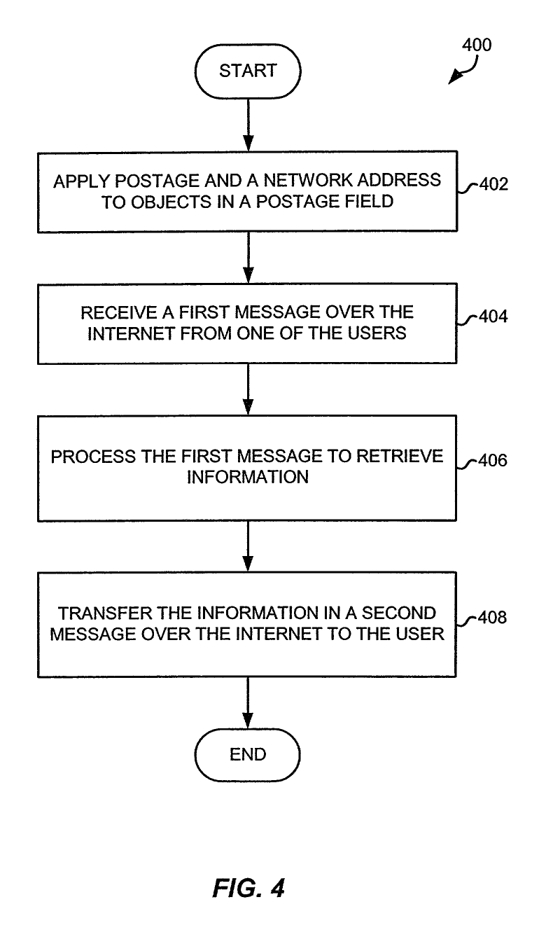

Method of Operating an Information Delivery System—FIG. 4

FIG. 4 illustrates a method 400 of operating an information delivery system in an example of the invention. Reference numbers from FIG. 4 are indicated in parenthesis below. The operation of other devices and systems may be discussed along with method 400, but is not intended to limit the scope of the invention. The method 400 includes applying (402) postage 204 and network address 206 to objects 180 in postage field 202. Those skilled in the art will appreciate that method includes applies postage 204 and network address 206 to multiple objects. Object 180 is delivered to user 121. Those skilled in the art will appreciate that user 121 could receive object 180 from the USPS, UPS, FedEx, or any other delivery service. User 121 enters network address 206 into user system 141 to generate a first message.

The method 400 includes receiving (404) the first message over the Internet 130 from user system 141. The first message is addressed to network address 206. The method 400 includes processing (406) the first message to retrieve information. The method 400 includes transferring (408) the information in a second message over the Internet 130 to user system 141.

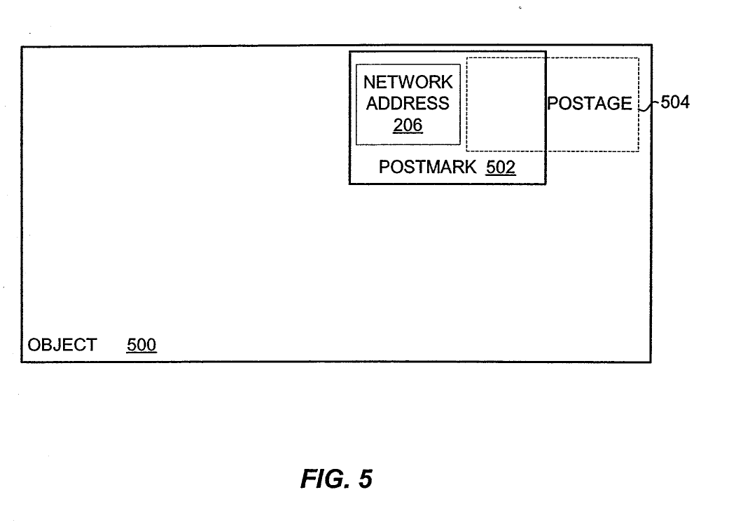

In another embodiment of the invention, the method 400 may further include generating a postmark that includes network address 206. A postmark is any indicator for canceling postage. FIG. 5 illustrates an object 500 that includes a postmark 502 applied to postage 504. Postmark 502 includes network address 206. Postmark 502 is stamped on postage 504 to cancel postage 504. By including network address 206 in postmark 502, postmark 502 can be used for advertising.

The method 400 may also include paying a delivery service to cancel postage 504 using postmark 502 that includes network address 206. For instance, a business could pay post offices to use a postmark containing the domain name of the business. Each piece of mail passing through the post offices will be stamped with the postmark that includes the domain name.

### EXAMPLE

The following is an example of how an information delivery system could be implemented. Assume that Company X wants to advertise its web site www.companyx.com. Company X then applies postage and the domain name www.companyx.com in a postage field of postcards, letters, packages, or any other object that Company X is sending through the USPS. A user receives one of the letters. The user automatically scans the domain name from the letter using a scanning device connected to the user's computer. The user's computer then automatically contacts the web site www.companyx.com responsive to scanning the domain name. The web site could be for paying a bill, getting product information, redeeming a coupon, or for some other variety of purposes.

1. An information delivery system, comprising:
a postage system configured to apply postage and a network address to objects in a postage field on the objects wherein the postage field comprises an area reserved on the objects for the postage and wherein the objects are delivered to users; and
a server system configured to receive a first message over the Internet from one of the users, wherein the first message is addressed to the network address, process the first message to retrieve information, and transfer the information in a second message over the Internet to the one of the users.

2. The information delivery system of claim 1 wherein the postage system is further configured to apply the network address in the postage field at a consistent location on the objects to enable the users to automatically scan the postage field for the network address.

3. The information delivery system of claim 1 further comprising a user system configured to automatically scan the network address from the postage field, generate the first message, and transfer the first message over the Internet.

4. The information delivery system of claim 1 wherein the postage system comprises a postage printing device configured to receive weight information for the objects and apply the postage based on the weight information.

5. The information delivery system of claim 1 wherein the network address comprises an Internet address.

6. The information delivery system of claim 1 wherein the network address comprises a domain name.

7. A method of operating an information delivery system, the method comprising:
applying postage and a network address to objects in a postage field on the objects wherein the postage field comprises an area reserved on the objects for the postage and wherein the objects are delivered to users;
receiving a first message over the Internet from one of the users wherein the first message is addressed to the network address;
processing the first message to retrieve information; and
transferring the information in a second message over the Internet to the one of the users.

8. The method of claim 7 further comprising applying the network address to the objects at a consistent location in the postage field to enable the users to automatically scan the postage field for the network address.

9. The method of claim 7 further comprising automatically scanning the network address from the postage field, generating the first message, and transferring the first message over the Internet.

10. The method of claim 7 further comprising receiving weight information for the objects and applying the postage based on the weight information.

11. The method of claim 7 wherein the network address comprises an Internet address.

12. The method of claim 7 wherein the network address comprises a domain name.

13. The method of claim 7 further comprising generating a postmark that includes the network address.

14. The method of claim 13 further comprising paying a delivery service to cancel the postage using the postmark that includes the network address.

15. A software product for a processing system that is configured to operate with a postage system, the software product comprising:
application software configured when executed by the processing system to direct the processing system to generate an instruction to apply postage and a network address to objects in a postage field on the objects wherein the postage field comprises an area reserved on the objects for the postage and wherein the objects are delivered to users, transfer the instruction to the postage system, receive a first message over the Internet from one of the users wherein the first message is addressed to the network address, process the first message to retrieve information, and transfer the information in a second message over the Internet to the one of the users; and
a storage media configured to store the application software.

16. The software product of claim 15 wherein the application software is further configured to direct the processing system to generate the instruction to apply the network address at a consistent location in the postage field to enable the users to automatically scan the postage field for the network address.

17. The software product of claim 15 wherein the application software is further configured to direct the processing system to receive weight information for the objects, generate a postage instruction based on the weight information, and transfer the postage instruction to the postage system.

18. The software product of claim 15 wherein the network address comprises an Internet address.

19. The software product of claim 15 wherein the network address comprises a domain name.

20. The software product of claim 15 wherein the application software is further configured to direct the processing system to change the network address applied to the objects.
